(19) United States
(12) Patent Application Publication
(10) Pub. No.: US 2019/0377919 A1
(43) Pub. Date: Dec. 12, 2019

(54) UNIQUE IDENTIFICATION CODE SYSTEM FOR ENTITY VERIFICATION

(71) Applicant: Nitin Gupta, Pune (IN)

(72) Inventor: Nitin Gupta, Pune (IN)

(21) Appl. No.: 16/005,722

(22) Filed: Jun. 12, 2018

(51) Int. Cl. G06K 7/14; G06K 19/06

(52) U.S. Cl. CPC G06K 7/1413; G06K 19/06028

(57) ABSTRACT

The present invention discloses a novel system and method of generation and verification of Unique Identification Code (UID Code), for authenticating and validating the genuineness of any Entity (product/service) associated with Unique Identification Code (UID Code); Wherein the system comprised of four components namely Unique identifier code Vault (UIDC Vault); Unique identifier code (UID Code); UID Code issuing authority (UIDC Authority) and UID Code Verifier (UIDC Verifier); and Wherein, the UID Code essentially comprise of two parts: Part 1. Visible part—part of code is visible and identifiable and Part 2. Protested Part—part of the code invisible protected and is available only after acquiring the entity (product/service).

### FIELD OF THE INVENTION

The present invention is generally relates to system and method to detect the counterfeit products, source of the products and assign unique code to original products.

### BACKGROUND OF THE INVENTION

With increase in usage of mobile and other Internet based facilities, the sale of various types of goods and products has also increased tremendously and so does the counterfeit product market. Product authentication has become a necessity in order to save the buyer as well the original seller of the products. The gray market of counterfeit products cause a billions of dollars losses to original product creators and also the end buyer is left cheated.

Numerous attempts were made in past in order to identify and develop a system to detect such products. Such as EP20110155987 discloses a product authentication system comprising an electronic tag for applying to a physical product, the tag comprising a memory, a number being stored in the memory, a mobile data processing device, the mobile data processing device being configured for reading the number from the tag, and wherein the mobile data processing device is configured for determining the authenticity of the product by determining the authenticity of the number.

Further, U.S. Pat. No. 7,287,696B2 discloses a system and method for decoding barcodes using mobile device. Generally, the barcode image is acquired via a digital camera attached to the mobile device. After the barcode image has been acquired, software located on the mobile device enhances the barcode image and subsequently decodes the barcode information. The barcode information is then transmitted to a server via a wireless network. The server processes the barcode information and transmits media content related to the barcode back to the mobile device.

And US20070228166A1 talks about a system and method to detect counterfeiting goods. In this invention, the user initiates the counterfeiting check by using a wireless device equipped with camera in his possession to take a picture of the anti-counterfeiting code pattern of a product item; and send the digital image to a host computer for checking. This invention further includes a second anti-counterfeiting code for user to examine so as to further ensure the authenticity of the product item,

From the above we see that the most common methods used currently for the authentication function, is by adding to the package a special component Such as a Barcode. Hologram. RFID tag. NFC etc.

Currently, although a number of means are used to validate the authenticity of products, such methods are not always reliable or user friendly for the purchaser of the product. The product authentication techniques based on holograms, RFID etc, can be easily imitated and re-produced and replicated as all it takes to copy the hologram is, give one of the original to the hologram printer company and it will give you exact copies of it, further RFID is no different than holograms when it comes to copying them. It is even easier, all you need is the RFID code set in one of the original item and set the same code in cloned RFID labels/tags, and you will be ready to pass the counterfeit check. So, we see anything that even though unique in case it is visible at the outset it can be replicated, hence there exists a requirement for a unique identifier that also has a unique hidden identifier.

The present invention seeks to provide a new authentication system that overcomes some of the disadvantages of prior art systems, from a number of aspects. According to the various embodiments of the present invention, the system enables a customer to verify the authenticity of the product he has or is going to purchase, in a fool proof. Secure and simple manner, wherein the code has two components namely visible and hidden.

### SUMMARY OF INVENTION

The present invention has been developed in response to the present state of the art, and in particular, in response to the problems and needs in the art that have not yet been fully solved by currently available techniques and processes. Accordingly, the present invention has been developed to provide an improvised system and method for detection and elimination of counterfeit products and goods from the entire supply chain. Accordingly, the invention discloses a novel system and method for companies' or individuals' or groups' to protect their brand and prevent counterfeit products and services.

The current invention system and method generates and uses Unique Identification Code (UID Code), to help verify the genuineness of any Entity (product/service) associated with it. Wherein, the UID Code essentially comprised of two parts: 1. Visible—This part of code is visible to everyone and is optional. 2. Protected—This part is protected and is supposed to be available only after acquiring the entity. The code may be packaged (or can be shipped separately) with the Entity whose genuineness it verifies.

In preferred embodiment, the UID Code produced against each entity (product/service or set of products/services), the entity information against the code is protected and associated with the UID Code. A system which, generates and manages UID Code and the associated entity information referred herein as UIDC Vault. UIDC Vault is responsible for generation of both the Visible and Protected part of the code (which can be, but not limited to, numeric, alphanumeric or some pattern or binary code), and creates a one way encryption of both the parts and stores them in a Database, which may in turn be further secured. The code may be put on the Tags (to be packaged with Entity) with visible part visible for anyone to scan and protected part to be available once the Product is acquired or purchased.

In another embodiment the Entity receiver or buyer can verify the genuineness of the entity by getting the information against the UID Code from the system and matching it with the received entity. Since the protected part is not available for anyone unless he or she acquires the product, its duplication is prevented.

In further embodiment. A set of algorithms can be put against the tracking of the code to catch anomalies and fight against the counterfeits. Therefore, the main objective of the present invention is to provide the system and method to detect counterfeit products essentially comprised of a system providing a direct interaction between the source client and the consumer, in order to ascertain product source.

### Objects of Invention

It is a primary object of the disclosed invention to provide a two layer unique code having one visible one hidden part, making it difficult to produce counterfeit of copies of the complete code as the hidden part is not the visible part.

It is further an object of the present invention to provide a system wherein the tag is secured through a two-way protection method wherein the tag is securely mathematically coupled to the protected tag. So anyone buying the tagged product, scratches and scans the protected tag, the open tag status is updated in the system and making any further scans of the open tag fails the counterfeit-check. This double protection disables the counterfeiter copies using the replicates of original open tag as the first scan of the protected tag will invalidate all the products with corresponding open tag.

It is yet another object of the present invention to provide an enhanced Physical protection is provided to each tag, i.e they can only be scratched or opened once after purchase. Once they are scanned their status gets updated on our system and they cannot be used again for authenticity check by any other device. They are mathematically coupled with the open tags. So any anomaly pattern on the open tags will lead to RED flagging of the closed tags too. Machine learning based anomaly detection system keeps monitoring the scan activity of the closed tags and the open tags. And immediately raises the RED flags for any abnormal or anomalous pattern.

It is an object of the invention to provide improved elements and arrangements thereof for the purposes described which is inexpensive, dependable and fully effective in accomplishing its intended purposes.

Other objects and advantages of the invention will become apparent as the foregoing description proceeds, taken together with the accompanying drawings and the appended claims.

### BRIEF DESCRIPTION OF ACCOMPANYING DRAWINGS

In order to describe the manner in which the above-recited and other advantages and features of the invention can be obtained, a more particular description of the invention briefly described above will be rendered by reference to specific embodiments thereof, which are illustrated in the appended drawings. And that the elements of similar structure or function are generally represented by reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram illustrating the architecture of the system and method of obtaining unique identifier code through first mechanism.

FIG. 2 is a block diagram illustrating the architecture of the system and method of obtaining unique identifier code through second mechanism.

FIG. 3 is the block diagram illustrating mechanism of verification of product through unique code obtained from first mechanism.

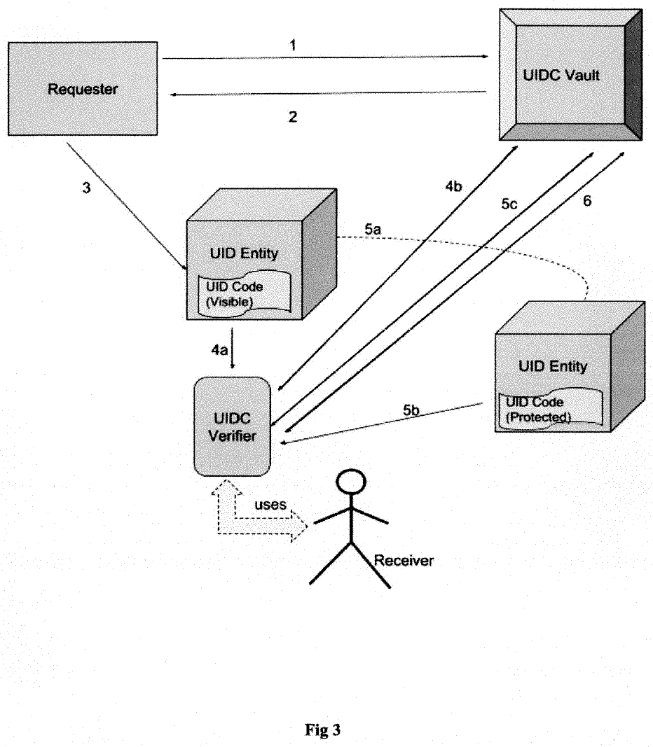

FIG. 4 is the block diagram illustrating mechanism of verification of product through unique code obtained from second mechanism.

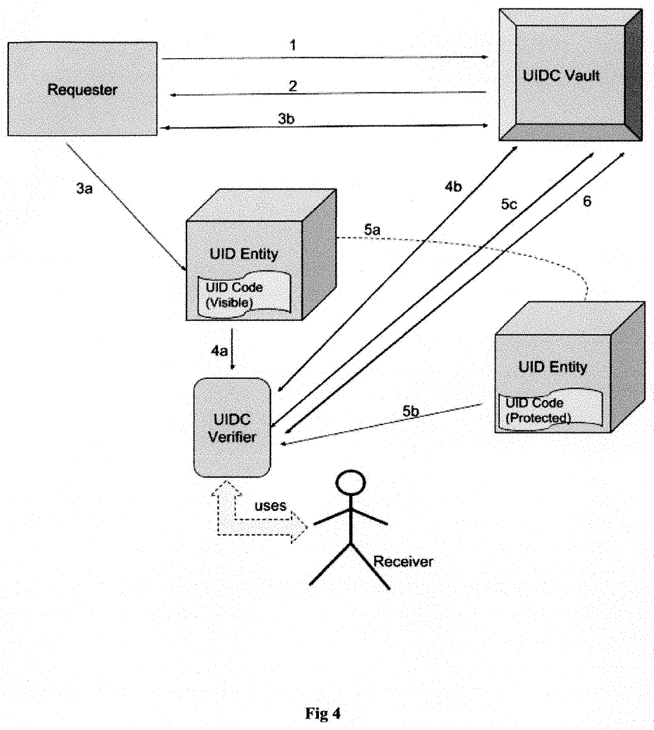

### DETAILED DESCRIPTION OF THE EMBODIMENTS

This invention disclosure describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention discloses Unique Identification Code System for Entity Verification wherein the code generated is novel code having two layer structure comprised of one visible one hidden part, making it difficult to produce counterfeit of copies of the complete code as the hidden part is not the visible part. The disclosed unique code visible part also referred as open tag is tightly mathematically coupled to the protected tag (hidden part).

The Unique Identification Code System for Entity Verification disclosed herein essentially comprised of four main components namely

A. Unique Identifier Code Vault (UIDC Vault)—A system which generates and manages UID Code and the associated entity information. This can be a system or a group of systems concentrated or distributed, which act as an inventory management system for storing and retrieving the information of, but not limited to. UID Entity and corresponding UID Code, UID Entity warranty information. Buyer and Requester information and Entity tracking, supply chain and marketing information. UIDC may internally store the UID Code or more or more of its logical or mathematical transformation or derivation by a two way encryption, mechanism or one way encrypted form or unencrypted form.

B. Unique Identifier Code (UID Code)—This can be any unique identifying pattern, which can consist of but not limited to numeric digits, alphanumeric characters, unique patterns, or any kind of unique combination of patterns or events. The UID Code may be visible (accessible to anyone) or protected (may be accessible only after but not limited to acquiring or purchasing or agreeing to acquire the entity) or a part of the UID Code may be visible and part protected (in some cases two or more UID Code may also be used, one or more to represent visible part and others to represent the protected).

C. UID Code issuing authority (UIDC Authority)—This can be one central or number of distributed authorities Products, Packages. Service or any entity physical or nonphysical which need to be uniquely identified.

D. UID Code Verifier (UIDC Verifier)—This can be a system such as but not limited to web-site or portal or an application (app) which ran be installed on devices such as but not limited to mobile phone or desktop or any other computing or electronic device, which can retrieve the information of the UID Entity for a UID Code from UID Vault or can just verify the validity (genuineness) of UID Entity without contacting UID Vault or any external entity, by using some inbuilt mechanism, such as but not limited to, public-private keys mechanism, certificate mechanism or one way encryption method or some different mathematical and/or logical algorithm or machine learning mechanism.

In the current invention the Requester who wants to send any entity to Receiver (receiver can be but not limited to buyer, distributor, reseller or anyone who need to verify the genuineness of the entity) receives the UID Code from the UIDC Authority for that entity. (The method to receive the UID Code can be in the form of but not limited to physical tags, stickers, hologram images, unique patterns, bar or line code. RFID tags, or other security tags or software code or self-generated code on screen) UIDC Authority puts the identifying and other information as provided by Requester about the Entity into the UID Vault and issues a UID Code for the Entity. When Receiver receives the Entity and its corresponding UID Code. Receiver uses the UIDC Verifier to retrieve the information of the UID Entity and checks it against the actually received Entity, UIDC Vault may record these activities for the analytical or other purposes. If Receiver is a buyer and he/she wants to know the Entity information or genuineness before purchase. Receiver may use the UIDC Verifier to retrieve the information of the UID Entity from the UID Code or a part of the code which is visible. If UID Code doesn't have visible part then buyer may be able to check the genuineness only after acquiring the protected part of the UID Code.

Now, the system and method of generation of UID code will be further explained in detail in the following disclosure. The current invention system and method may generate the code through two mechanisms.

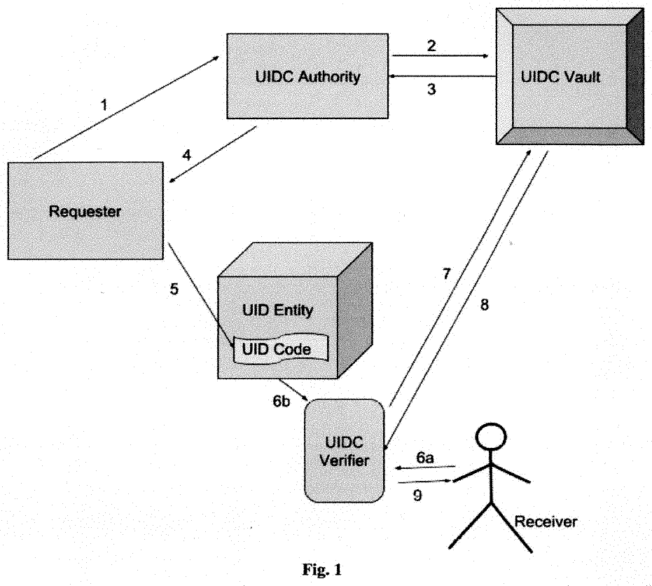

FIG. 1 is a block diagram illustrates the architecture of the system and method of obtaining unique identifier code through first mechanism.

In the first mechanism, wherein in Step 1. Requester requests one or Set of UID Codes from UIDC Authority and provides the entity information at the time of request. This request leads to Step 2. Wherein UIDC Authority asks the required number of UID Codes from UIDC Vault (UIDC Authority and UIDC Vault may be the same entity or a part of the same entity or system) and provides the entity information. In step 3. UIDC Authority receives the required number of UID Codes (in the form of but not limited to physical tags or non-physical tags) from UIDC Vault. Further, in Step 4. Requester receives the Tags from UIDC Authority either directly or indirectly via another agent or set of agents or layers in between. In step 5. The Requester the UID Code get associated with the physical or non-physical product (UID Entity) in the form of but not limited to tags, stickers, print on entity or cover or on any other entity associated with it. 6a. Receiver (Buyer) initiates UIDC verification via UIDC Verifier. 6b. UIDC Verifier gets the UID Code. In step 7. UIDC Verifier send the UID Code to UIDC Vault for verification, proceed to Step 8. Wherein the UIDC Receiver receives the UID Code from UIDC Vault and In step 9. UIDC conveys the appropriate message to the Receiver However. 7 and 8 step could happen within the UIDC Verifier where it can verify the UID Code without contacting the UIDC Vault, via some mathematical or logical computations such as but not limited to using public and private keys or other mathematical algorithm or logical mechanism or machine learning mechanism or combination of them,

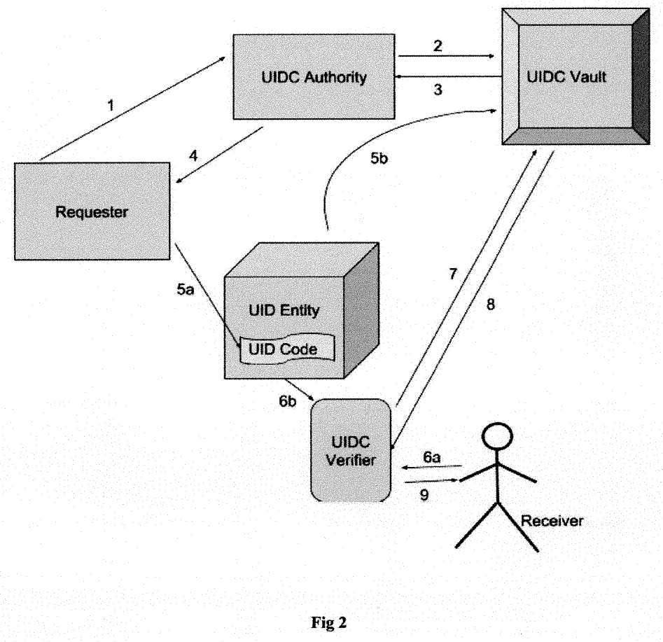

FIG. 2 is a block diagram illustrates the architecture of the system and method of obtaining unique identifier code through second mechanism. Wherein in step: 1. Requester requests one or set of UID Codes from UIDC Authority without providing the entity information at the time of request. In Step 2. UIDC Authority asks the required number of UID Codes from UIDC Vault (UIDC Authority and UIDC Vault may be the same entity or a part of the same entity or system) In step 3. UIDC Authority gets the required number of UID Codes (in the form of but not limited to physical tags or non-physical lags) from UIDC Vault. Further. In step 4. Requester receives the Tags from UIDC Authority either directly or in-directly via another agent or set of agents or layers in between. Step 5 may either proceed to 5a. From Requester the UID Code gets associated with the physical or non-physical product (UID Entity) in the form of but not limited to tags, stickers, print on entity or cover or on any other entity associated with it. Or 5b. Requester updates the UIDC Vault (either directly or indirectly via UIDC Authority) with the UID Entity information. In some cases step 5b can happen before step 5a. 6a. Receiver (Buyer) initiates UIDC verification via UIDC Verifier. 6b. UIDC Verifier gets the UID Code. In step 7. UIDC Verifier send the UID Code to UIDC Vault for verification. In step 8. UIDC Receiver receives the UID Code from UIDC Vault. In step 9. UIDC conveys the appropriate message to the Receiver However, Step 7 and step 8 may happen within the UIDC Verifier where it can verify the UID Code without contacting the UIDC Vault, via some mathematical or logical computations such as but not limited to using public and private keys or other mathematical algorithm or logical mechanism or machine Learning mechanism or combination of them.

In another aspect, the invention is letting a buyer check the genuineness of the branded product with some probability before the purchase: 1. Buyer scans the Visible part of the UID Code on the product with the UIDC Verifier. 2. UIDC Verifier retrieves the information from the UIDC Vault and if the part of the UID Code is identifiable the UIDC Vault conveys the appropriate information of the product. 3. If the UID Code is not found or there is some other issue (such as but not limited to. UID Code is already used or UID Code warranty is already registered, or UID Code item is recalled, or UID Code item is stolen), it conveys the same, 4. From this information Buyers gets a rough idea of the genuineness of the product.

In yet another aspect, the disclosed invention is letting a buyer check the genuineness of the branded product with certainty after the purchase: 1. Buyer acquires the protected part of the UID Code on the product and scans it with the UIDC Verifier. 2. UIDC Verifier retrieves the information from the UIDC Vault and if the UID Code is identifiable the UIDC Vault conveys the appropriate information of the product (such as but not limited to products manufacturer details, product details, its life cycle, its distribution chain, and its intended market for sale and any other marketing related information). 3. If the UID Code is not found or there is some other issue (such as but not limited to. UID Code is already used or UID Code warranty is already registered, or UID Code item is recalled, or UID Code item is stolen), it conveys the same. 4. From this information Buyers has the certainty of genuineness of the product as the protected pa cannot be duplicated without acquiring it.

In further aspect, the invention is letting a buyer check the genuineness of the branded product with some probability before purchase and after the purchase with certainty: 1. Buyer scans the the Visible part of the UID Code on the product with the UDC Verifier. 2. UIDC Verifier retrieves the information from the UIDC Vault and if the part of the UID Code is identifiable the UIDC Vault conveys the appropriate information of the product 3. If the UID Code is not present or there is some other issue, it conveys the same. 4. From this information Buyer gets a rough idea of the genuineness of the product, 5. Buyer acquires the protected part of the UID Code on the product (after but not limited to purchasing the product) and scans the protected part with the UIDC Verifier. 6. UIDC Verifier retrieves the information from the UIDC Vault and if the UID Code is identifiable the UIDC Vault conveys the appropriate information of the product (such as but not limited to products manufacturer details, product details, its life cycle, its distribution chain, and its intended market for sale and any other marketing related information). 7. If the UID Code is not found or there is some other issue (such as but not limited to, UID Code is already used or UID Code warranty is already registered, or UID Code item is recalled, or UID Code item is stolen), it conveys the same. 8. From this information Buyers has the certainty of genuineness of the product as the protected part of UID Code cannot be duplicated without acquiring it. In another embodiment, the invention is letting the Requester receive the whereabout of the UID Entity or a group of UID Entities when anyone scans the UID Code (either visible or protected part or both): 1. Whenever potential buyers scan the code the UIDC Vault may store the location and other useful information for the analytical purpose 2. The UID Code for the group of entities or individual entity can be scanned by the agents or representatives in the supply chain, which can help Vault keep the information of the items location in supply chain. To provide useful analytics.

In another embodiment, the invention is letting a buyer check the genuineness of the branded product after the purchase with certainty and register for Warranty provided by the product manufacturer or supplier (or Requester): 1. Buyer acquires the protected part of the UID Code on the product and scans it with the UIDC Verifier. 2. UIDC Verifier retrieves the information from the UIDC Vault and if the UID Code is identifiable the UIDC Vault conveys the appropriate information of the product (such as but not limited to products manufacturer details, product details, its life cycle, its distribution chain, and its intended market for sale and any other marketing related information). 3. If the UID Code is not found or there is some other issue (such as but not limited to, UID Code is already used or UID Code warranty is already registered, or UID Code item is recalled, or UID Code item is stolen), it conveys the same. 4. From this information Buyers has the certainty of genuineness of the product as the protected part can only be acquired after purchase. 5. UID Verifier directly or indirectly (through third party system) can show the buyer form to fill to acquire the product warranty. UIDC Vault or third party system can store the buyer's filled information, other related information and/or warranty information.

In another embodiment, the invention is letting a buyer register for Warranty provided by the product manufacturer or supplier (or Requester): 1. Buyer acquires the protected part of the UID Code on the product and scans it with the UIDC Verifier, 2. UIDC Verifier retrieves the information from the UIDC Vault and directly or indirectly (through third party system) shows the buyer form to fill to acquire the product warranty. UIDC Vault or third party system can store the buyer's filled information, other related information and/or warranty information.

In another embodiment, the invention is letting a buyer transfer the Warranty provided by the product manufacturer or supplier (or Requester) as allowed by the product manufacturer or supplier (or Requester): 1. Buyer acquires the protected part of the UID Code on the product and scans it with the UIDC Verifier. 2. UIDC Verifier retrieves the information from the UIDC Vault and directly or indirectly (through third party system) shows the buyer form to fill to acquire the product warranty. UIDC Vault or third party system can store the buyer's filled information, other related information and/or warranty information. 3. If Buyer sells or resells it to another Buyer (New Buyer) then UIDC Verifier can show the warranty transfer form from UIDC Vault directly or indirectly (through third party system), and let the warranty be transferred to New Buyer.

In another embodiment, the invention is discouraging the counterfeit products in the market: 1. As the Buyer acquires the protected part of the UID Code and can verify the genuineness of the product with certainty. The protected part of the UID Code may be made to be used only once by the UIDC Vault (as per Requester's request) and may be made accessible only after acquiring the product. As the UIDC Vault records the product info from the genuine manufacturers (brands or Requesters) and issue the UID Codes only to them, the counterfeit manufacturers will not be able to provide the Genuineness guarantee to the Buyers. So they can be easily identified by the buyers and their goods will be declined over the time. 2. Buyers can now have the certainty that they bought a genuine product, when they can verify the UID Code with UIDC Vault. The Buyers who prefer branded products would naturally prefer to buy from the shop which sells the genuine products rather than from the shops which sells counterfeit products.

In another embodiment invention pertains to a new mechanism of generating and using Unique Identification Code (UID Code) to help verify the genuineness of any Entity associated with it.

Referring to Diagram-3 1. Requester requests for one or set of UID Codes to the UIDC Vault. Requester chooses to associate the entity information with the UID Codes at the time of request, so it provides the entity details to the UIDC Vault. 2. UIDC Vault generates or issues, already generated, unused UID Codes to the Requester and associates the Entity information with the UID Codes. UIDC Vault can generate the Codes list and can securely transmit them or it can directly send the UID Codes in the form of Protected Physical Tags which can have only protected Part or both Visible and Protected Parts. 3. The Requester packages the tags with Entity (Product) they are associated with. 4a. Before purchasing the entity, buyer scans the Visible part of UID Code. 4b. With the help of UIDC Verifier (on mobile or any other device) buyer sends the code and receives more details and some estimation of genuineness of the product from UIDC Vault. 5a. Buyer purchases the product 5b. Buyer can access the protected part of the tag (to access the protected part of UID Code the cover of the protected part may need to be destroyed or torn or peeled off) and scans the Protected part of UID Code 5c. With the help of UIDC Verifier (on mobile or any other device) buyer sends the code and receives more details and certainty about the genuineness of the product from UIDC Vault. If the UID Code is not present or has already been used, buyer gets the appropriate information. 6. Optionally UIDC Verifier may also receive product's warranty form or other promotional form which it can prompt Buyer to fill and submit. Which UIDC Vault may store with and/or sends the information to the Product manufacturer or Company (or Requester) Once the Protected part of the UID Code is used, the UIDC Vault may store the time the Protected code is first used and optionally location where it is used and other information such as but not limited to IP address, device info and may convey that the UID Code is already used and a part of the other accessed information, if the Protected part of the UID Code is used again. This prevents the duplicated use of UID Code. UIDC Vault may also store the information such as but not limited to IP address, time, time-zone, location information whenever the Protected or Visible part of the UID Code is accessed. And may use this information to generate other analytical information for the Buyers and the Requesters.

In another embodiment invention pertains to a new mechanism of generating and using Unique Identification Code (UID Code) to help verify the genuineness of any Entity associated with it when the entity information is not supplied at the time of UID Code generation. Referring to Diagram-4 1. Requester requests for one or set of UID Codes to the UIDC Vault. Requester chooses to associate the entity information with the UID Codes at the later point of time. 2. UIDC Vault generates or issues already generated unused UID Codes to the Requester. UIDC Vault can generate the Codes list and can securely transmit them or it can directly send the UID Codes in the form of Protected Physical Tags which can have only protected Part or both Visible and Protected Parts. 3a. The Requester packages the tags with Entity (Product) they are associated with. 3b. Requester requests to associates the Entity information with the UID Codes in UIDC Vault. And UIDC Vault associates the Entity information with the UID Codes and sends the confirmation/acknowledgement. Step 3b may happen before or after Step 3a. 4a. Before purchasing the entity, buyer scans the Visible part of UID Code 4b. With the help of UIDC Verifier (on mobile or any other device) buyer sends the code and receives more details and some estimation of genuineness of the product from UIDC Vault. 5a, Buyer purchases the product and 5b. Buyer can access the protected part of the tag (to access the protected part of UID Code the cover of the protected part may need to be destroyed or torn or peeled off) and scans the Protected part of UID Code 5c. With the help of UIDC Verifier (on mobile or any other device) buyer sends the code and receives more details and certainty about the genuineness of the product from UIDC Vault. If the UID Code is not present or has already been used, buyer gets the appropriate information. 6. Optionally UIDC Verifier may also receive product's warranty form or other promotional form which it can prompt Buyer to fill and submit. Which UIDC Vault may store with and/or sends the information to the Product manufacturer or Company (or Requester). Once the Protected part of the UID Code is used, the UIDC Vault may store the time the Protected code is first used and optionally location where it is used and other information such as but not limited to IP address, device info and may convey that the UID Code is already used and a part of the other accessed information, if the Protected part of the UID Code is used again. This prevents the duplicated use of UID Code. UIDC Vault may also store the information such as but not limited to IP address, time, time-zone, location information whenever the Protected or Visible part of the UID Code is accessed. And may use this information to generate other analytical information for the Buyers and the Requesters.

The user in current invention may initiate an authenticity check by performing simple steps, mainly by scanning the unique identifier allotted to a particular product he wants to testify. The user may scan the code by virtue of a smart phone having a camera and the software application. The scanning device may be a mobile device including, but not limited to, a smartphone, a tablet PC, or a PDA. The scanning device may include, for example, a camera, an RFID radio, a cellular radio, a Wi-Fi radio, and a global positioning system (GPS) radio. The camera and RFID radio may be used to scan a readable indicia, and the cellular radio, Wi-Fi radio, and GPS radio may be used for location services. The scanning device may further include an application (e.g., a mobile application) that enables scanning of the readable indicia on the products and documents, and communication with the remote server.

The system may be built on a Cloud computing platform that includes all necessary hardware, software and services securely hosted at the remote server. All necessary computing resources may be exposed through XML SOAP (Simple Object Access Protocol) and Representational State Transfer (RESTful) Web Services. Downloadable mobile applications configured to interface with the system platform may be loaded onto the print device and/or the scanning device.

A computer program, having one or more program modules, may be stored in memory, as well as an operating system, one or more application programs, other program modules, and program data. Each of the operating system, one or more application programs, other program modules, and program data or some combination thereof, may include an implementation of a networking environment. The program modules may carry out the functions and/or methodologies of embodiments of the invention as described herein.

Since other modifications and changes varied to fit particular operating requirements and environments are apparent to those skilled in the art, the invention is not considered limited to the example chosen for purposes of disclosure and covers all changes and modifications which do not constitute departures from the true spirit and scope of this invention.

This written description uses examples to disclose the invention, including the best mode, and also to enable any person skilled in the art to practice the invention, including making and using any devices or systems and performing any incorporated methods. The above are merely exemplary and illustrative of the inventive concept by, one of ordinary skill in the art in the specific embodiments described to make various modifications or additions, or a similar alternative manner, without departing from the invention. The invention, as defined in this disclosure or beyond the scope of the claims, should belong to the scope of the present invention,

I claim:

1. A system and method of generation and verification of Unique Identification Code (UID Code), for authenticating and validating the genuineness of any Entity (product/service) associated with Unique Identification Code (UID Code);
Wherein the system comprised of four components namely Unique identifier code Vault (UIDC Vault); Unique identifier code (UID Code); UID Code issuing authority (UIDC Authority) and UID Code Verifier (UIDC Verifier); and
Wherein, the UID Code essentially comprise of two parts: Part 1, Visible part—part of code is visible and identifiable and Part 2, Protected Part—part of the code invisible, protected and is available only after acquiring the entity (product/service).

2. The system and method of generation and verification of Unique Identification Code (UID Code) as claimed in claim 1, wherein the UID Code produced against each entity (product/service), the entity information against the code is protected and associated with the UID Code.

3. The system and method of generation and verification of Unique Identification Code (UID Code) as claimed in claim 1, wherein UIDC Vault generates and manages UID Code and the associated entity information, UIDC Vault generates both the Visible and Protected part of the code; and creates a one way encryption of both the parts and stores them in a Database, which may in turn be further secured.

4. The system and method of generation and verification of Unique Identification Code (UID Code) as claimed in claim 1, wherein the UID code may be put on the Tags packaged with Entity with visible part available for scan and protected part to be available once the entity is acquired or purchased.

5. The system and method of generation and verification of Unique identification Code (UID Code) as claimed in claim 1, wherein the system can verify the genuineness of the entity by getting the information against the UID Code from the system and matching it with the received entity.

6. The system and method of generation and verification of Unique Identification Code (UID Code) as claimed in claim 1, wherein the tag is securely mathematically coupled to the protected part of the UID Code.

7. The system and method of generation and verification of Unique Identification Code (UID Code) as claimed in claim 1, wherein once the protected part of the code is used, the open tag status is updated in the system and making any further scans of the open tag fails the counterfeit-check; disabling the counterfeiter copies using the replicates of original open tag as the first scan of the protected tag invalidate for all the products with corresponding open tag.

8. The system and method of generation and verification of Unique Identification Code (UID Code) as claimed in claim 1, wherein the Buyer scans the Visible part of the UID Code on the product with the UIDC Verifier; the UIDC Verifier retrieves the information from the UIDC Vault and if the part of the UID Code is identifiable the UIDC Vault conveys the appropriate information of the product or If the UID Code is not found or there is some other issue, such as but not limited to, UID Code is already used or UID Code warranty is already registered, or UID Code item is recalled, or UID Code item is stolen, it conveys the same to the buyer.

9. The system and method of generation and verification of Unique Identification Code (UID Code) as claimed in claim 1, wherein UIDC Vault may also store the information such as but not limited to IP address, time, time-zone, location information whenever the Protected or Visible part of the UID Code is accessed and may use this information to generate other analytical information for the Buyers and the Requesters.
